(19) United States
(12) Patent Application Publication
(10) Pub. No.: US 2017/0270362 A1
(43) Pub. Date: Sep. 21, 2017

(54) Responsive Augmented Content

(71) Applicant: DAQRI, LLC, Los Angeles, CA (US)

(72) Inventors: Arye Barnehama, Venice, CA (US); Jonathan Freeman, Los Angeles, CA (US); Laura Berman, Venice, CA (US)

(21) Appl. No.: 15/073,958

(22) Filed: Mar. 18, 2016

(51) Int. Cl. G06K 9/00; G06T 19/00; G06F 3/01; H04W 4/02

(52) U.S. Cl. CPC G06K 9/00671; H04W 4/023; G06T 19/003; G06F 3/012; G06T 19/006

(57) ABSTRACT

A wearable computing device includes at least one processor, a display element configured to display augmented reality (AR) content to a wearer of the wearable computing device and presenting a field of view to the wearer, a location sensor providing location information associated with the wearable computing device, and an augmented reality (AR) engine. The AR engine is configured to identify a location of the wearable computing device and a location of a first device within the environment, receive an operating status of the first device, determine a first AR element associated with the first device based on the operating status of the first device and the location of the first device relative to the location of the wearable computing device, and display the first AR element using the display element, the first AR element is displayed at a display location approximately aligned with or proximate to the location of the first device within the field of view.

### TECHNICAL FIELD

The subject matter disclosed herein generally relates to augmented content. Specifically, the present disclosure addresses systems and methods using a display device to provide augmented content to wearers for site and event management.

### BACKGROUND

An augmented reality (AR) device can be used to generate and display data in addition to an image captured with the AR device. For example, AR is a live, direct, or indirect view of a physical, real-world environment whose elements are augmented by computer-generated sensory input such as sound, video, graphics or Global Positioning System (GPS) data. With the help of advanced AR technology (e.g., adding computer vision and object recognition) the information about the surrounding real world of the user becomes interactive. Device-generated (e.g., artificial) information about the environment and its objects can be overlaid on the real world.

Some types of tasks, such as field service work in oil refining, mining, or construction, may require workers to operate tools and machinery with their hands while performing some tasks. During the course of operation, field service workers may need to be alerted to the occurrence of events, such as emergency situations or dangerous conditions arising at a particular site. For example, an oil derrick may erupt in flames at an oil field. Conventional routines may require operations managers to alert their field service workers to the event manually, such as through radio or cellular communication directly with the individual workers. Such conventional routines have problems mobilizing the proper individuals and relaying critical information to all of those individuals about the event.

### BRIEF DESCRIPTION OF THE DRAWINGS

Some embodiments are illustrated by way of example and not limitation in the figures of the accompanying drawings.

FIG. 1 is a network diagram illustrating a site management system suitable for operating an augmented reality (AR) application with a display device (e.g., a HMD device or other mobile computing device), according to some example embodiments.

FIG. 2 is a block diagram illustrating modules (e.g., components) of the display device, according to some example embodiments.

FIG. 3 illustrates the display controller which, in the example embodiment, includes a receiver module and an actuation module.

FIG. 4 is a block diagram illustrating modules (e.g., components) of the wearable device, according to some example embodiments.

FIG. 5 is a block diagram illustrating an example embodiment of a server.

FIG. 6A illustrates the site management system providing AR assist functionality to a wearer of a HMD, which may be similar to the user and the HMD, respectively, shown in FIG. 1.

FIG. 6B illustrates the field of view of the wearer as seen through the HMD in the scenario shown in FIG. 6A.

FIG. 6C illustrates the field of view if, for example, the wearer were to look up slightly from the field of view as shown in FIG. 6B such that the focus area overlaps with the device region of the device.

FIG. 7A illustrates the site management system providing AR event assistance functionality to a wearer of a HMD during an event, which may be similar to the user and the HMD, respectively, shown in FIG. 1.

FIG. 7B illustrates the field of view of the wearer as seen through the HMD at the time the alert is received by the HMD.

FIG. 7C illustrates the event field of view of the wearer as seen through the HMD after reorienting the HMD to point toward the event site (e.g., as prompted by the alert and associated AR objects).

FIG. 7D illustrates the event field of view of the wearer as seen through the HMD after crossing the first threshold (e.g., while in the planning zone).

FIGS. 8A-8H illustrate a computerized method, in accordance with an example embodiment, for providing AR assist functionality to a wearer of an HMD.

FIG. 9 is a block diagram illustrating components of a machine, according to some example embodiments, able to read instructions from a machine-readable medium and perform any one or more of the methodologies discussed herein.

FIG. 10 is a block diagram illustrating a mobile device, according to an example embodiment.

### DETAILED DESCRIPTION

Example methods and systems are directed to a site management system leveraging a display device of a user (e.g., a head-mounted display (HMD) worn by a field service worker). Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, the display device includes a wearable computing device (e.g., a helmet) with a display surface including a display lens capable of displaying augmented reality (AR) content, enabling the wearer to view both the display surface and their surroundings. The helmet may include a computing device such as a hardware processor with an AR application that allows the user wearing the helmet to experience information, such as in the form of a virtual object such as a three-dimensional (3D) virtual object overlaid on an image or a view of a physical object (e.g., a gauge) captured with a camera in the helmet. The helmet may include optical sensors. The physical object may include a visual reference (e.g., a recognized image, pattern, or object, or unknown objects) that the AR application can identify using predefined objects or machine vision. A visualization of the additional information (also referred to as AR content), such as the 3D virtual object overlaid or engaged with a view or an image of the physical object, is generated in the display lens of the helmet. The display lens may be transparent to allow the user see through the display lens. The display lens may be part of a visor or face shield of the helmet or may operate independently from the visor of the helmet. The 3D virtual object may be selected based on the recognized visual reference or captured image of the physical object. A rendering of the visualization of the 3D virtual object may be based on a position of the display relative to the visual reference. Other AR applications allow the user to experience visualization of the additional information overlaid on top of a view or an image of any object in the real physical world. The virtual object may include a 3D virtual object, or a two-dimensional (2D) virtual object. For example, the 3D virtual object may include a 3D view of an engine part of an animation. The 2D virtual object may include a 2D view of a dialog box, menu, or written information such as statistics information for properties or physical characteristics of the corresponding physical object (e.g., temperature, mass, velocity, tension, stress). The AR content (e.g., image of the virtual object, virtual menu) may be rendered at the helmet or at a server in communication with the helmet. In one example embodiment, the user of the helmet may navigate the AR content using audio and visual inputs captured at the helmet, or other inputs from other devices, such as a wearable device. For example, the display lenses may extract or retract based on a voice command of the user, a gesture of the user, a position of a watch in communication with the helmet.

A system and method for site management using augmented reality with a display device is described. In one example embodiment, users such as field service workers wear an HMD during their work day. The HMDs operate as a part of a site management system that provides alerts and event information to wearers with AR content provided using the HMDs. The site management system provides various event-related AR content to the wearer, including initial event notification, site direction (e.g., based on orientation or pose of the wearer and the HMD), event status and data, machine status and data, and task information (e.g., for addressing an event). The site management system provides this AR content based on timing and proximity between the wearer and a piece of equipment of interest (e.g., at the event site), showing more summary-type information (e.g., early in the alerting process, or the farther that the wearer is from the site). As the event progresses, and/or as the wearer moves nearer the event site, the site management system provides AR content in greater detail until, at the event site, the AR content displays specific information and task instructions useful in addressing the event, or other detailed information related to the equipment of interest.

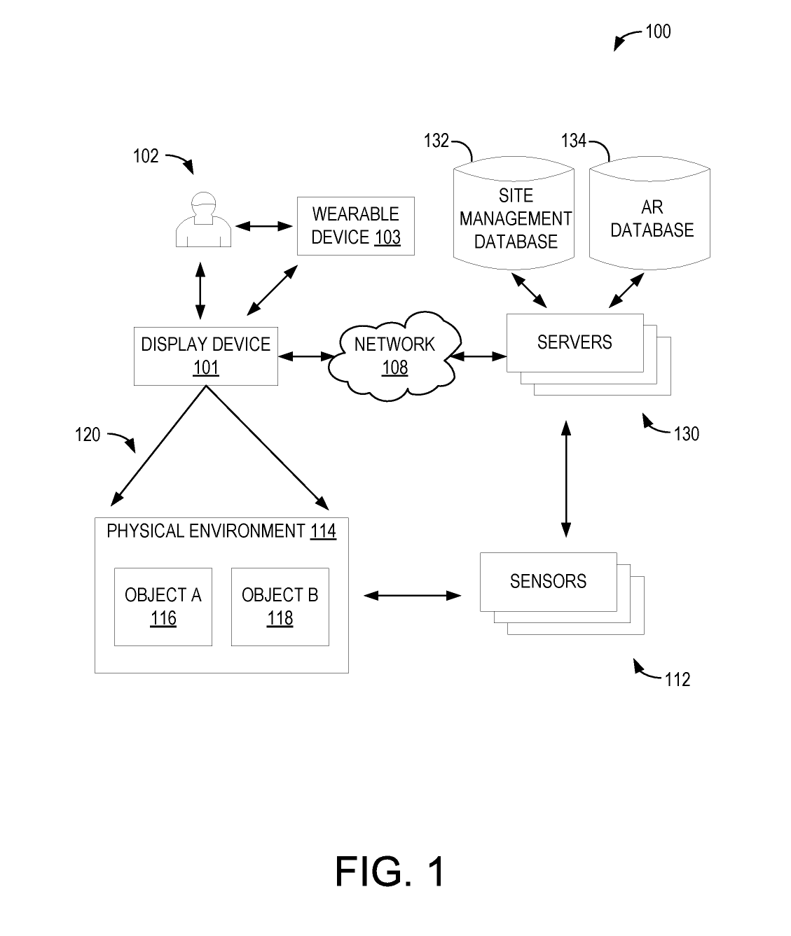

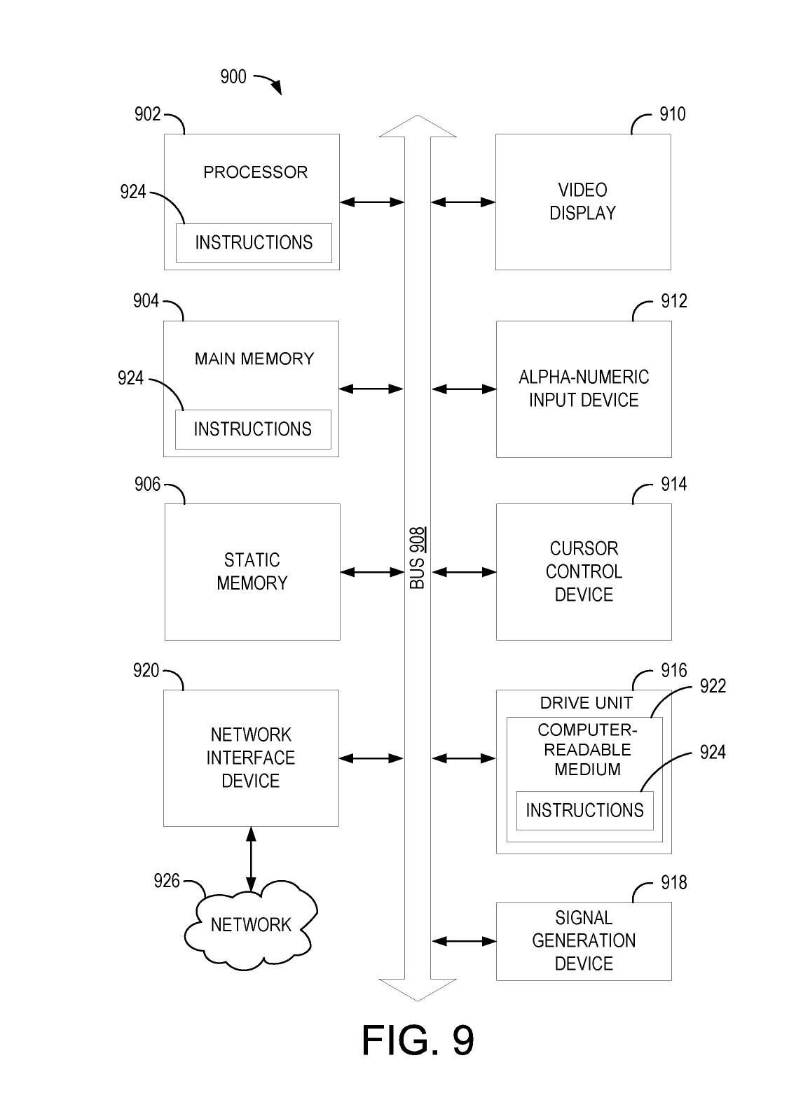

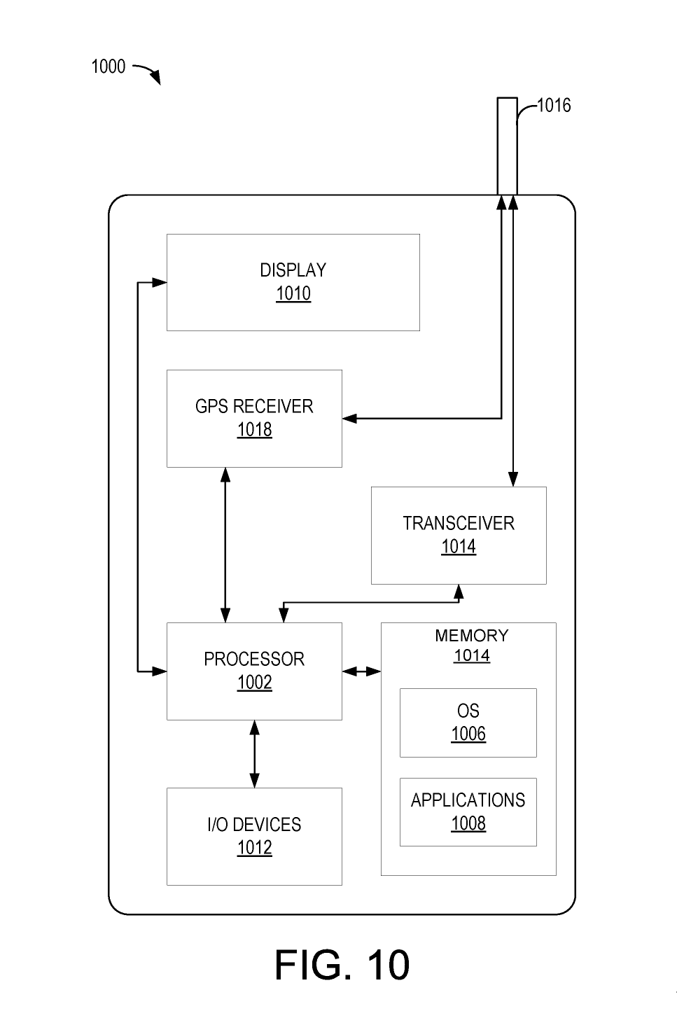

FIG. 1 is a network diagram illustrating a site management system 100 suitable for operating an augmented reality (AR) application with a display device 101 (e.g., a HMD device or other mobile computing device), according to some example embodiments. The site management system 100 includes the display device 101, one or more servers 130, and a site management database 132, communicatively coupled to each other via a network 108. The display device 101 and the servers 130 may each be implemented in a computer system, in whole or in part, as described below with respect to FIGS. 9 and 10.

The servers 130 may be part of a network-based system. For example, the network-based system may be or include a cloud-based server system that provides AR content (e.g., augmented information including 3D models of virtual objects related to physical objects captured by the display device 101) to the display device 101.

The display device 101 may include a helmet that a user (or “wearer”) 102 may wear to view the AR content related to captured images of several physical objects (e.g., object A 116, object B 118) in a real world physical environment 114. In one example embodiment, the display device 101 includes a computing device with a camera and a display (e.g., smart glasses, smart helmet, smart visor, smart face shield, smart contact lenses). The computing device may be removably mounted to the head of the user 102. In one example, the display may be a screen that displays what is captured with a camera of the display device 101 (e.g., unaugmented, or augmented with AR content). In another example, the display of the display device 101 may be a transparent or semi-transparent surface such as in the visor or face shield of a helmet, or a display lens distinct from the visor or face shield of the helmet (e.g., onto which AR content may be displayed).

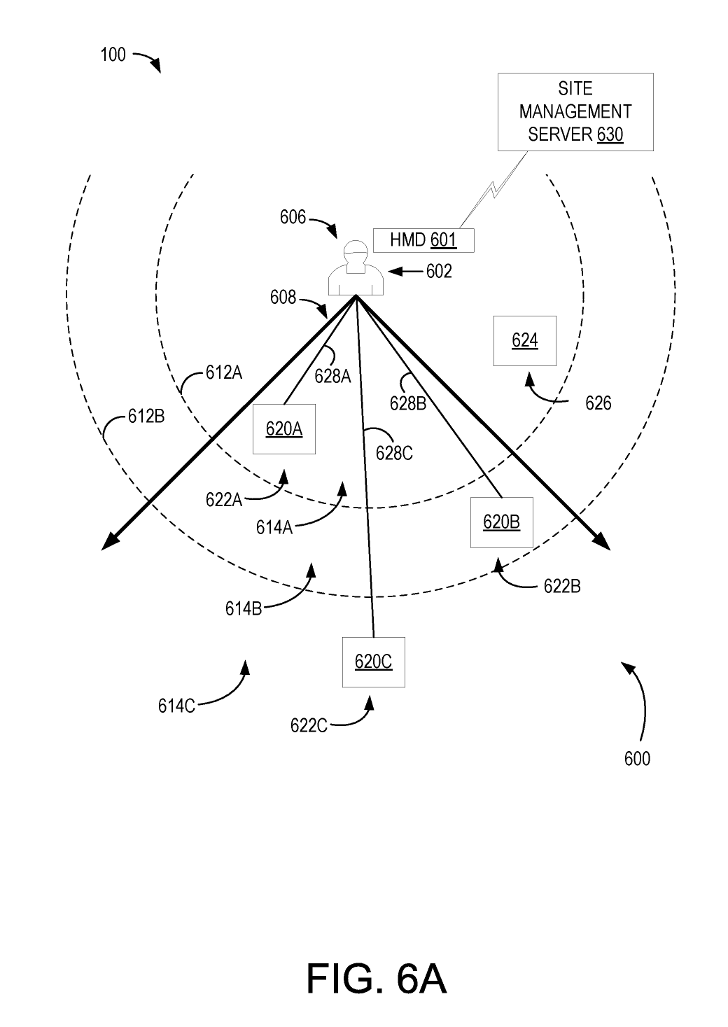

The user 102 may wear a wearable device 103 (e.g., a watch). The wearable device 103 communicates wirelessly with the display device 101 to enable the user 102 to control extension and retraction of the display. Components of the wearable device 103 are described in more detail with respect to FIG. 4.

The user 102 may be a user of an AR application in the display device 101 and at the servers 130. The user 102 may be a human user (e.g., a human being), a machine user (e.g., a computer configured by a software program to interact with the display device 101), or any suitable combination thereof (e.g., a human assisted by a machine or a machine supervised by a human). The AR application may provide the user 102 with an AR experience triggered by identified objects 116, 118 in the physical environment 114. The physical environment 114 may include identifiable objects 116, 118 such as, for example, a 2D physical object (e.g., a picture), a 3D physical object (e.g., a factory machine), a location (e.g., at the bottom floor of a factory), or any references (e.g., perceived corners of walls or furniture) in the real world physical environment 114. The AR application may include computer vision recognition to determine corners, objects, lines, and letters. The user 102 may point a camera of the display device 101 to capture an image of the objects 116 and 118 in the physical environment 114.

In one example embodiment, the objects 116, 118 in the image are tracked and recognized locally in the display device 101 using a local context recognition dataset or any other previously stored dataset of the AR application of the display device 101 (e.g., locally on the display device 101 or from an AR database 134). The local context recognition dataset module may include a library of virtual objects associated with real-world physical objects 116, 118 or references. In one example, the display device 101 identifies feature points in an image of the objects 116, 118 to determine different planes (e.g., edges, corners, surface, dial, letters). The display device 101 may also identify tracking data related to the objects 116, 118 (e.g., GPS location of the display device 101, orientation, distances to objects 116, 118). If the captured image is not recognized locally at the display device 101, the display device 101 can download additional information (e.g., 3D model or other augmented data) corresponding to the captured image, from the AR database 134 over the network 108.

In another embodiment, the objects 116, 118 in the image are tracked and recognized remotely at the server 130 using a remote context recognition dataset or any other previously stored dataset of an AR application in the server 130 and the AR database 134. The remote context recognition dataset module may include a library of virtual objects or augmented information associated with real-world physical objects 116, 118 or references.

Sensors 112 may be associated with, coupled to, or related to the objects 116, 118 in the physical environment 114 (e.g., to measure a location, information, or reading of the objects 116, 118). Examples of measured reading may include and but are not limited to weight, pressure, temperature, velocity, direction, position, intrinsic and extrinsic properties, acceleration, and dimensions. For example, sensors 112 may be disposed throughout a factory floor to measure movement, pressure, orientation, and temperature. The servers 130 can compute readings from data generated by the sensors 112. The servers 130 can generate virtual indicators such as vectors or colors based on data from sensors 112. Virtual indicators are then overlaid on top of a live image of the objects 116, 118 to show data related to the objects 116, 118. For example, the virtual indicators may include arrows with shapes and colors that change based on real-time data. The visualization may be provided to the display device 101 so that the display device 101 can render the virtual indicators in a display of the display device 101. In another embodiment, the virtual indicators are rendered at the servers 130 and streamed to the display device 101. The display device 101 displays the virtual indicators or visualization corresponding to a display of the physical environment 114 (e.g., data is visually perceived as displayed adjacent to the objects 116, 118).

The sensors 112 may include other sensors used to track the location, movement, and orientation of the display device 101 externally without having to rely on sensors internal to the display device 101. The sensors 112 may include optical sensors (e.g., depth-enabled 3D camera), wireless sensors (Bluetooth, Wi-Fi), GPS sensor, and audio sensor to determine the location of the user 102 having the display device 101, distance of the user 102 to the tracking sensors 112 in the physical environment 114 (e.g., sensors 112 placed in corners of a venue or a room), the orientation of the display device 101 to track what the user 102 is looking at (e.g., direction at which the display device 101 is pointed, display device 101 pointed towards a player on a tennis court, display device 101 pointed at a person in a room).

In another embodiment, data from the sensors 112 and internal sensors in the display device 101 may be used for analytics data processing at the servers 130 (or another server) for analysis on usage and how the user 102 is interacting with the physical environment 114. Live data from other servers may also be used in the analytics data processing. For example, the analytics data may track at what locations (e.g., points or features) on the physical or virtual object the user 102 has looked, how long the user 102 has looked at each location on the physical or virtual object, how the user 102 moved with the display device 101 when looking at the physical or virtual object, which features of the virtual object the user 102 interacted with (e.g., such as whether a user 102 tapped on a link in the virtual object), and any suitable combination thereof. The display device 101 receives a visualization content dataset related to the analytics data. The display device 101 then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIGS. 9 and 10. As used herein, a “database” is a data storage resource and may store data structured as a text file, a table, a spreadsheet, a relational database (e.g., an object-relational database), a triple store, a hierarchical data store, or any suitable combination or other format known in the art. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 130), databases (e.g., site management database 132), and devices (e.g., display device 101, wearable device 103). Accordingly, the network 108 may be a wired network, a wireless network (e.g., Wi-Fi, mobile, or cellular network), or any suitable combination thereof. The network 108 may include one or more portions that constitute a private network, a public network (e.g., the Internet), or any suitable combination thereof.

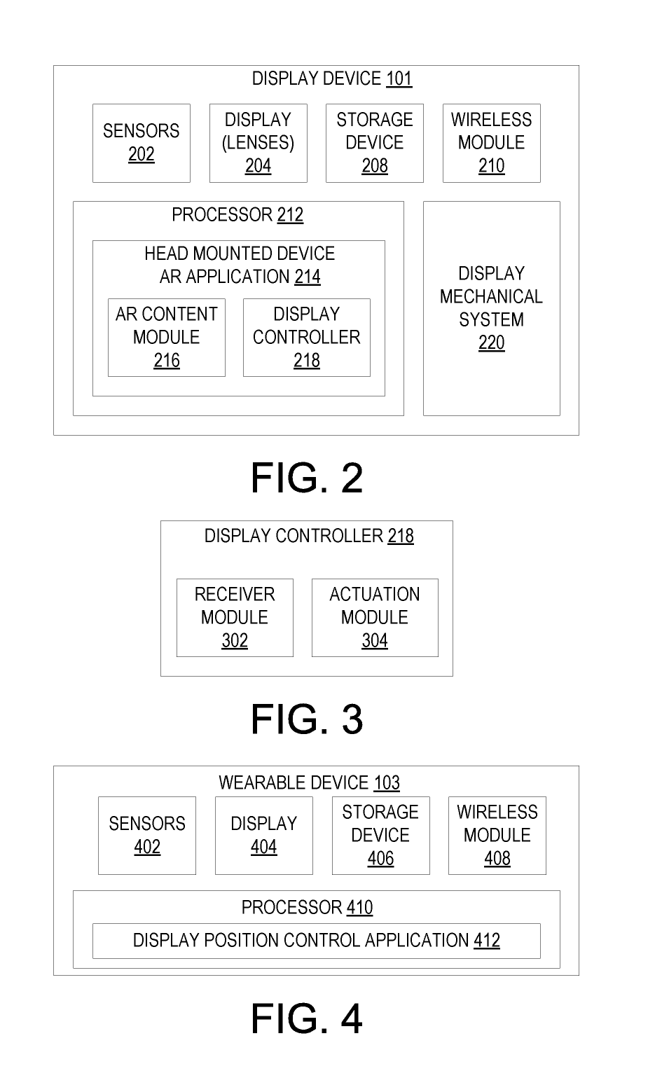

FIG. 2 is a block diagram illustrating modules (e.g., components) of the display device 101, according to some example embodiments. The display device 101 may be a helmet that includes sensors 202, a display 204, a storage device 208, a wireless module 210, a processor 212, and display mechanical system 220.

The sensors 202 may include, for example, a proximity or location sensor (e.g., near field communication, GPS, Bluetooth, Wi-Fi), an optical sensor(s) (e.g., camera), an orientation sensor(s) (e.g., gyroscope, or an inertial motion sensor), an audio sensor (e.g., a microphone), or any suitable combination thereof. For example, the sensors 202 may include rear facing camera(s) and front facing camera(s) disposed in the display device 101. It is noted that the sensors 202 described herein are for illustration purposes. Sensors 202 are thus not limited to the ones described. The sensors 202 may be used to generate internal tracking data of the display device 101 to determine, for example, what the display device 101 is capturing or looking at in the real physical world, or how the display device 101 is oriented. For example, a virtual menu may be activated when the sensors 202 indicate that the display device 101 is oriented downward (e.g., when the user 102 tilts his head to watch his wrist).

The display 204 includes a display surface or lens capable of displaying AR content (e.g., images, video) generated by the processor 212. In some embodiments, the display 204 may also include a touchscreen display configured to receive a user input via a contact on the touchscreen display. In some embodiments, the display 204 may be transparent or semi-transparent so that the user 102 can see through the display lens 204 (e.g., such as in a heads-up display).

The storage device 208 may store a database of identifiers of wearable devices 103 capable of communicating with the display device 101. In another embodiment, the database may also include visual references (e.g., images) and corresponding experiences (e.g., 3D virtual objects, interactive features of the 3D virtual objects). The database may include a primary content dataset, a contextual content dataset, and a visualization content dataset. The primary content dataset includes, for example, a first set of images and corresponding experiences (e.g., interaction with 3D virtual object models). For example, an image may be associated with one or more virtual object models. The primary content dataset may include a core set of images or the most popular images determined by the server 130. The core set of images may include a limited number of images identified by the server 130. For example, the core set of images may include the images depicting covers of the ten most viewed devices and their corresponding experiences (e.g., virtual objects that represent the ten most sensing devices in a factory floor). In another example, the server 130 may generate the first set of images based on the most popular or often scanned images received at the server 130. Thus, the primary content dataset does not depend on objects or images scanned by the display device 101.

The contextual content dataset includes, for example, a second set of images and corresponding experiences (e.g., three-dimensional virtual object models) retrieved from the server 130. For example, images captured with the display device 101 that are not recognized (e.g., by the server 130) in the primary content dataset are submitted to the server 130 for recognition (e.g., using the AR database 134). If the captured image is recognized by the server 130, a corresponding experience may be downloaded at the display device 101 and stored in the contextual content dataset. Thus, the contextual content dataset relies on the context in which the display device 101 has been used. As such, the contextual content dataset depends on objects or images scanned by the recognition module of the display device 101.

In one embodiment, the display device 101 may communicate over the network 108 with the servers 130 and/or AR database 134 to retrieve a portion of a database of visual references, corresponding 3D virtual objects, and corresponding interactive features of the 3D virtual objects.

The wireless module 210 comprises a component to enable the display device 101 to communicate wirelessly with other machines such as the servers 130, the site management database 132, the AR database 134, and the wearable device 103. The wireless module 210 may operate using Wi-Fi, Bluetooth, and other wireless communication means.

The processor 212 may include an HMD AR application 214 (e.g., for generating a display of information related to the objects 116, 118). In one example embodiment, the HMD AR application 214 includes an AR content module 216 and a display controller 218. The AR content module 216 generates a visualization of information related to the objects 116, 118 when the display device 101 captures an image of the objects 116, 118 and recognizes the objects 116, 118 or when the display device 101 is in proximity to the objects 116, 118. For example, the HMD AR application 214 may generate a display of a holographic or virtual menu visually perceived as a layer on the objects 116, 118. The display controller 218 is configured to control the display 204. For example, the display controller 218 controls an adjustable position of the display 204 in the display device 101 and controls power supplied to the display 204.

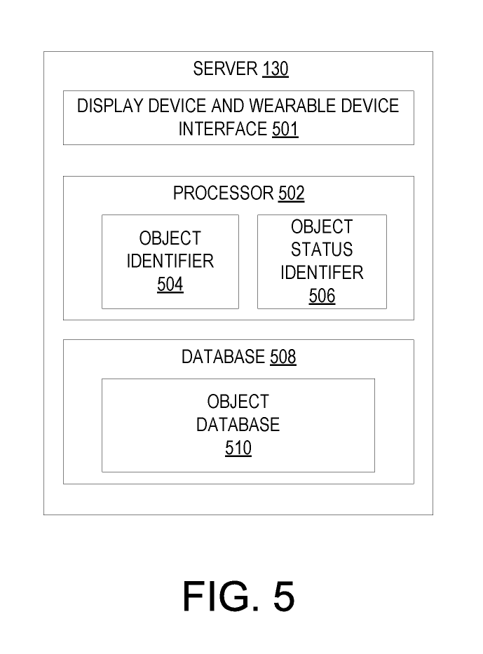

FIG. 3 illustrates the display controller 218 which, in the example embodiment, includes a receiver module 302 and an actuation module 304. The receiver module 302 communicates with sensors 202 in the display device 101 and the wearable device 103 to identify commands related to the display 204. For example, the receiver module 302 may identify an audio command (e.g., “lower glasses”) from the user 102 to lower a position of the display 204. In another example, the receiver module 302 may identify that AR content is associated with objects 116, 118, and may lower the display 204 in the display device 101. If no AR content is identified, the display 204 remains hidden in the display device 101. In another example, the receiver module 302 determines whether AR content exists at the physical environment 114 based on the AR content module 216 and the server 130. In another example, the receiver module 302 identifies a signal from the wearable device 103 (e.g., command from the wearable device 103 to lower the display 204, position of the wearable device 103 relative to the display device 101—lowered or raised) and adjusts the position of the display 204 based on the signal.

The actuation module 304 generates an actuation command to the display mechanical system 220 (e.g., motor, actuator) to raise the display 204 inside the display device 101 or lower the display 204 outside the display device 101 based on the determination made from the receiver module 302.

Any one or more of the modules described herein may be implemented using hardware (e.g., a processor 212 of a machine) or a combination of hardware and software. For example, any module described herein may configure a processor 212 to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 4 is a block diagram illustrating modules (e.g., components) of the wearable device 103, according to some example embodiments. The wearable device 103 may include sensors 402, a display 404, a storage device 406, a wireless module 408, and a processor 410.

The sensors 402 may include, for example, a proximity or location sensor (e.g., NFC, GPS, Bluetooth, Wi-Fi), an optical sensor(s) (e.g., camera), an orientation sensor(s) (e.g., gyroscope, or an inertial motion sensor), an audio sensor (e.g., a microphone), or any suitable combination thereof.

The display 404 may also include a touchscreen display configured to receive a user input via a contact on the touchscreen display. In one example, the display 404 may include a screen configured to display images generated by the processor 410. The storage device 406 stores information about the display device 101 for authentication. The wireless module 408 includes a communication device (e.g., Bluetooth device, Wi-Fi device) that enables the wearable device 103 to wirelessly communicate with the display device 101.

The processor 410 may include a display position control application 412 for adjusting a position of the display 404 of the display device 101. In one example embodiment, the display position control application 412 identifies operations on the wearable device 103 to the display device 101. For example, the display position control application 412 may detect that the user 102 has pushed a particular button of the wearable device 103. The display position control application 412 communicates that information to the display device 101 to identify a position of the display 404 based on the button that was pushed. The wearable device 103 may include one physical button for raising the display 404 of display device 101 and another physical button for lowering the display 404 of display device 101.

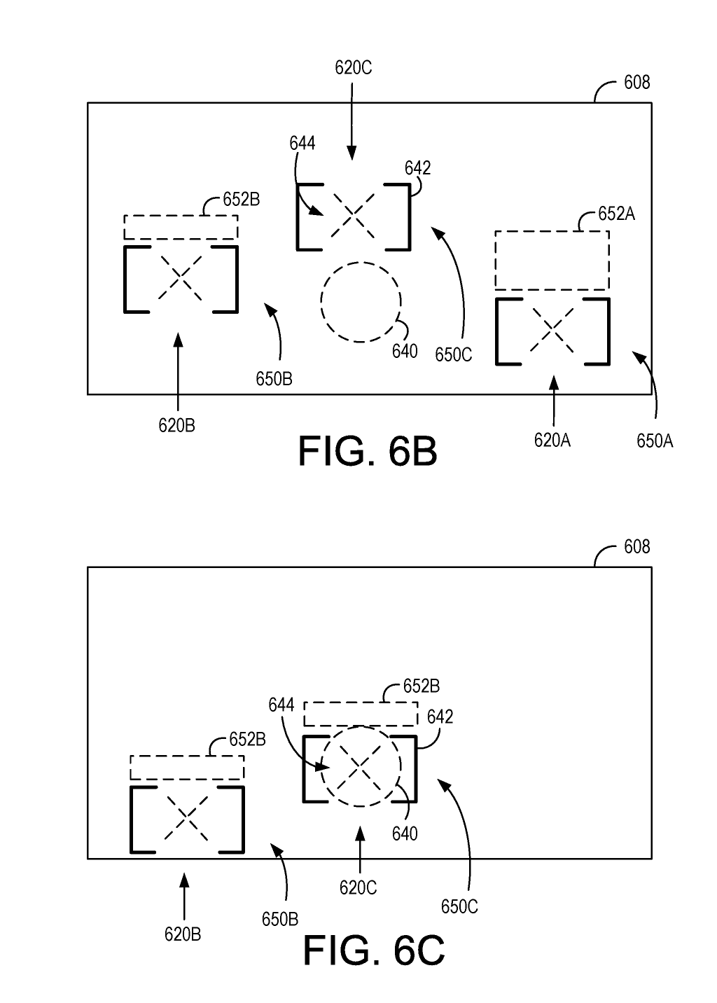

FIG. 5 is a block diagram illustrating modules (e.g., components) of the server 130. The server 130 includes a display device and wearable device interface 501, a processor 502, and a database 508. The display device and wearable device interface 501 may communicate with the display device 101, the wearable device 103, and sensors 112 to receive real time data. The database 508 may be similar to the AR database 134 and/or the site management database 132.

The processor 502 may include an object identifier 504 and an object status identifier 506. The object identifier 504 may identify objects 116, 118 based on a picture or image frame received from the display device 101. In another example, the display device 101 has already identified objects 116, 118 and has provided the identification information to the object identifier 504. The object status identifier 506 determines the physical characteristics associated with the devices identified. For example, if the device is a gauge, the physical characteristics may include functions associated with the gauge, location of the gauge, reading of the gauge, other devices connected to the gauge, safety thresholds or parameters for the gauge. AR content may be generated based on the object 116, 118 identified and a status of the object 116, 118.

The database 508 may store an object dataset 510. The object dataset 510 may include a primary content dataset and a contextual content dataset. The primary content dataset comprises a first set of images and corresponding virtual object models. The contextual content dataset may include a second set of images and corresponding virtual object models.

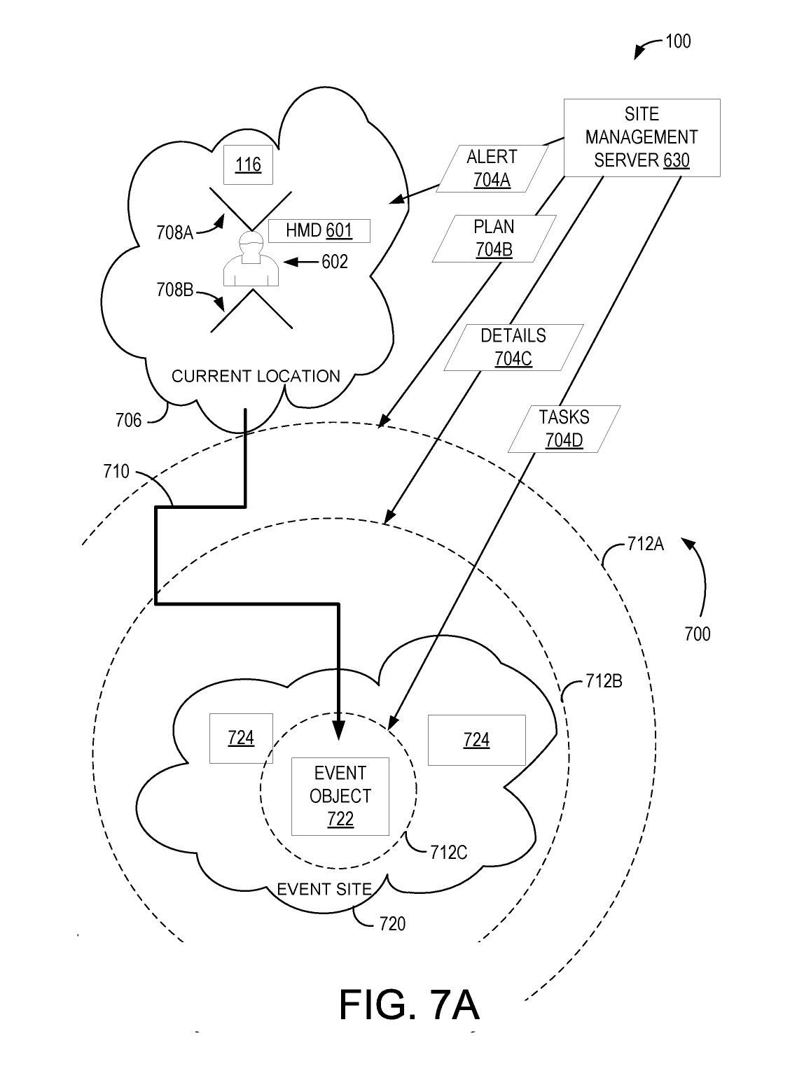

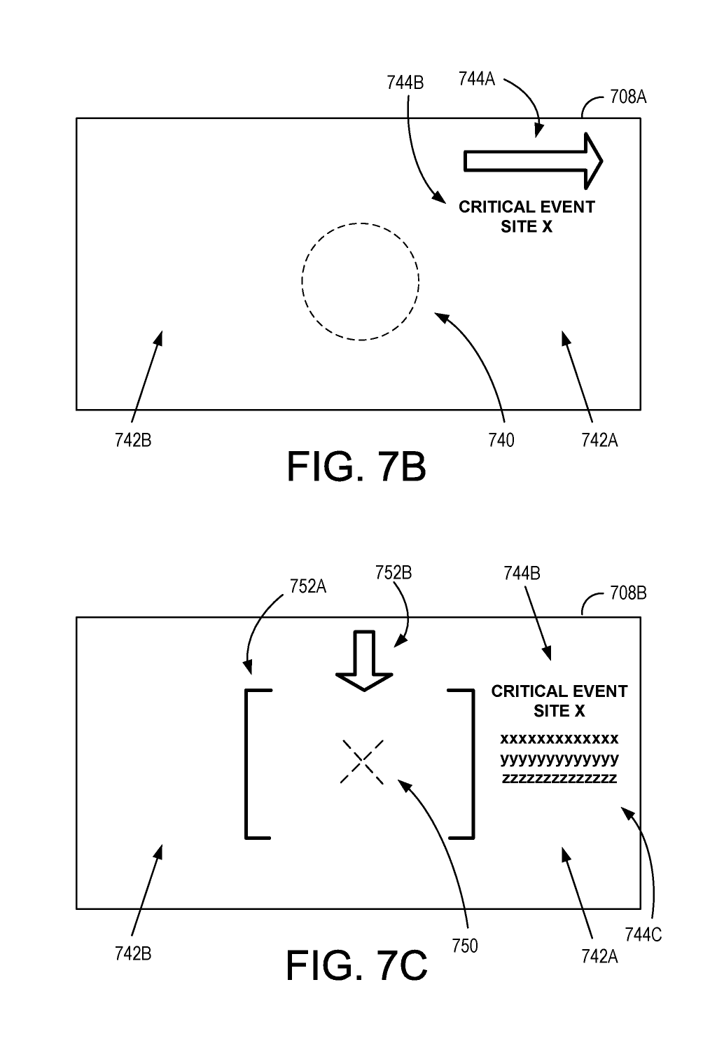

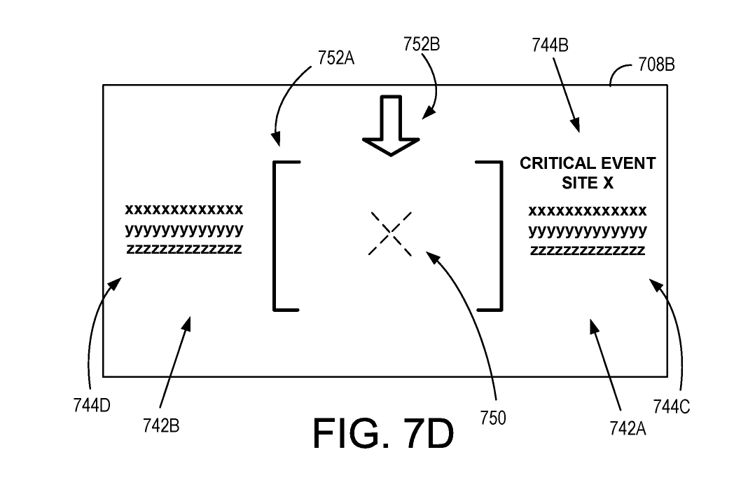

FIG. 6A illustrates the site management system 100 providing AR assist functionality to a wearer 602 of a HMD 601, which may be similar to the user 102 and the display device 101, respectively, shown in FIG. 1. In the example embodiment, the wearer 602 is a field service worker performing service operations in a work environment 600 (e.g., an oil refinery, a construction site, a power generation plant). The site management system 100 includes a site management server 630 in communication with the wearer 602 through the HMD 601 (e.g., via wireless networking, cellular networking). The site management system 100 provides various VR assist functionalities to the wearer 602 while in use (e.g., during the wearer's work day). The wearer 602 may, for example, be involved with managing or maintaining equipment at the work environment 600. In the example embodiments shown and described with respect to FIGS. 6A-8, the HMD 601 acts as a display device for the user (e.g., the wearer 602). It should be understood, however, that other types of display devices are possible.

In the example embodiment, the wearer 602 is working at a current location (or “wearer location”) 606 (e.g., a particular position within the work environment 600) while wearing the HMD 601. Within the work environment 600 are devices 620A, 620B, 620C (collectively, “devices 620”), and 624 that, for example, may be devices of interest to the wearer 602. For example, the wearer 602 may be an industrial engineer tasked with managing, monitoring, or servicing power generators at a power generation plant (e.g., work environment 600), and the devices 620, 624 may be electric power generators or other support equipment associated with power generation. Further, each of the devices 620, 624 have a location 622A, 622B, 622C, 626 known to the site management server 630 and/or the HMD 601 (e.g., known GPS coordinates). In some embodiments, some or all of the devices 620, 624 may be in communication with the site management server 630, and may transmit status, location, and other operational data to and from the site management server 630 during operation.

In the example shown in FIG. 6A, the wearer 602 views the environment 600 through the HMD 601 and, more specifically, is oriented such as to have a field of view 608 (e.g., as seen through the HMD 601) across a portion of the environment 600. The field of view 608 is angled such as to include the devices 620A, 620B, and 620C, but not device 624, which is too far to the left of the wearer 602. The wearer 602 may or may not have a direct line of sight to any of the devices 620.

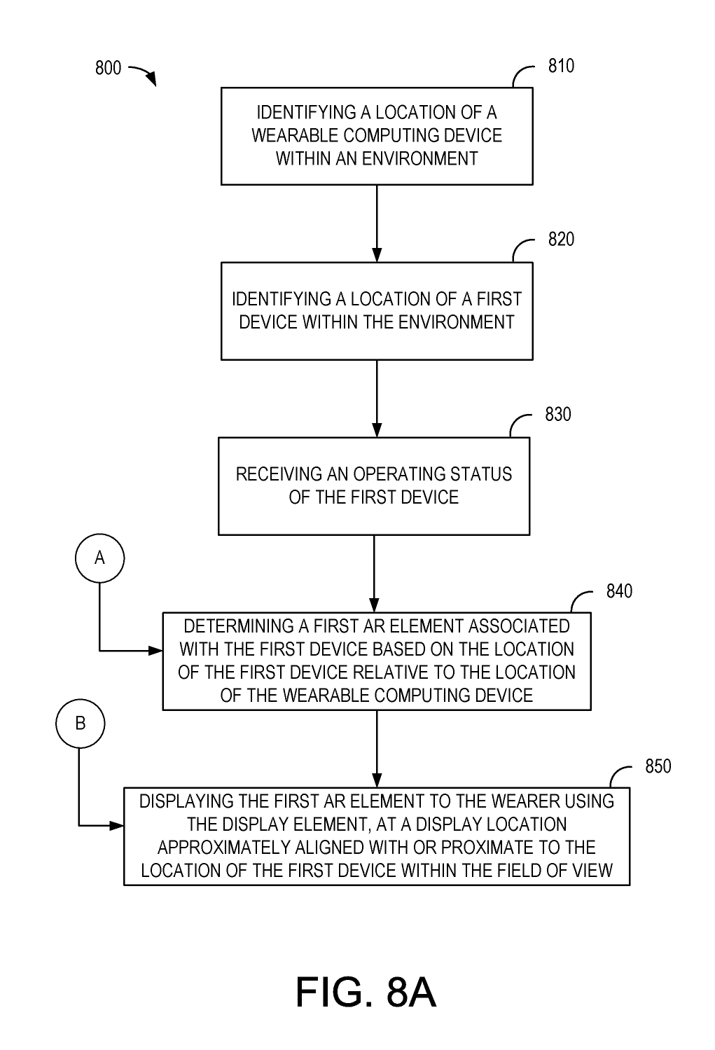

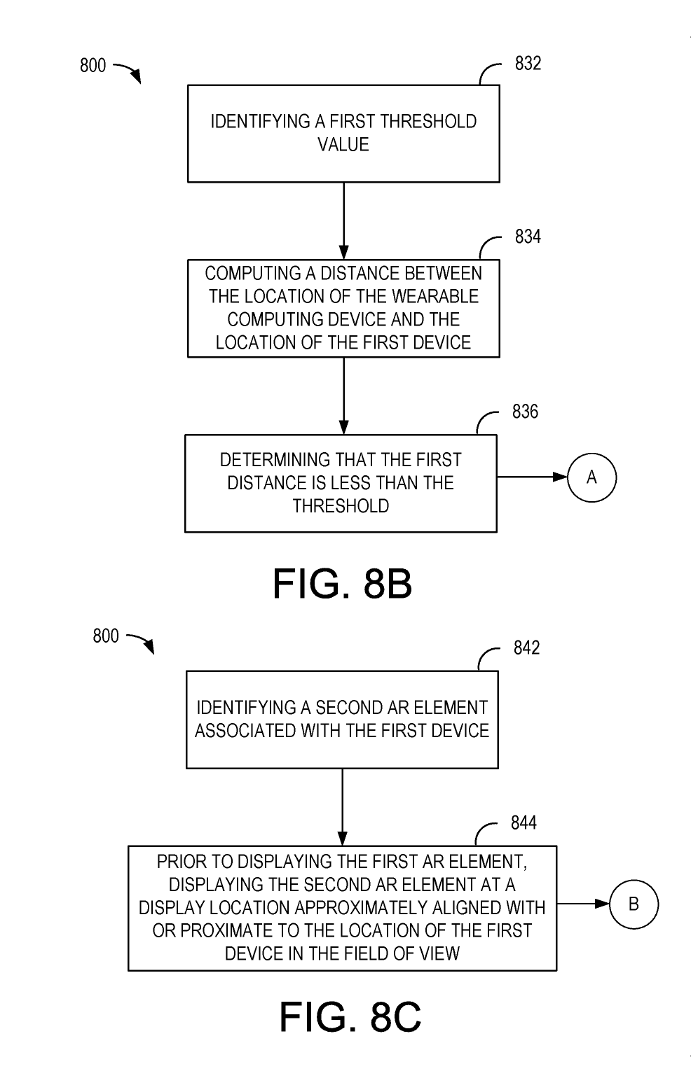

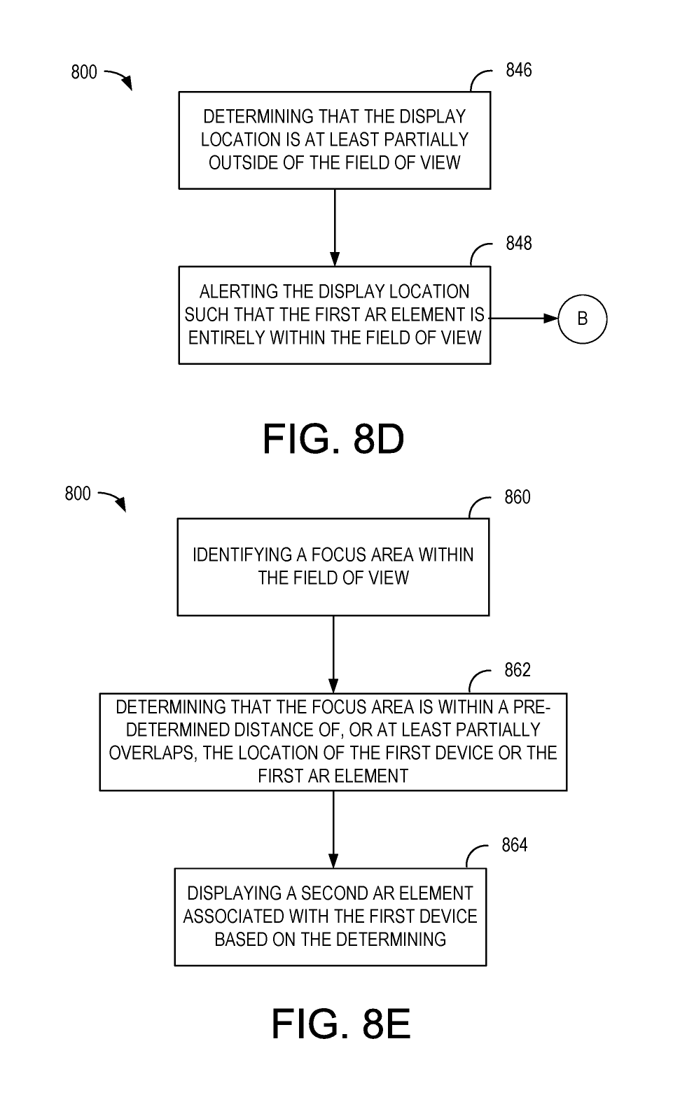

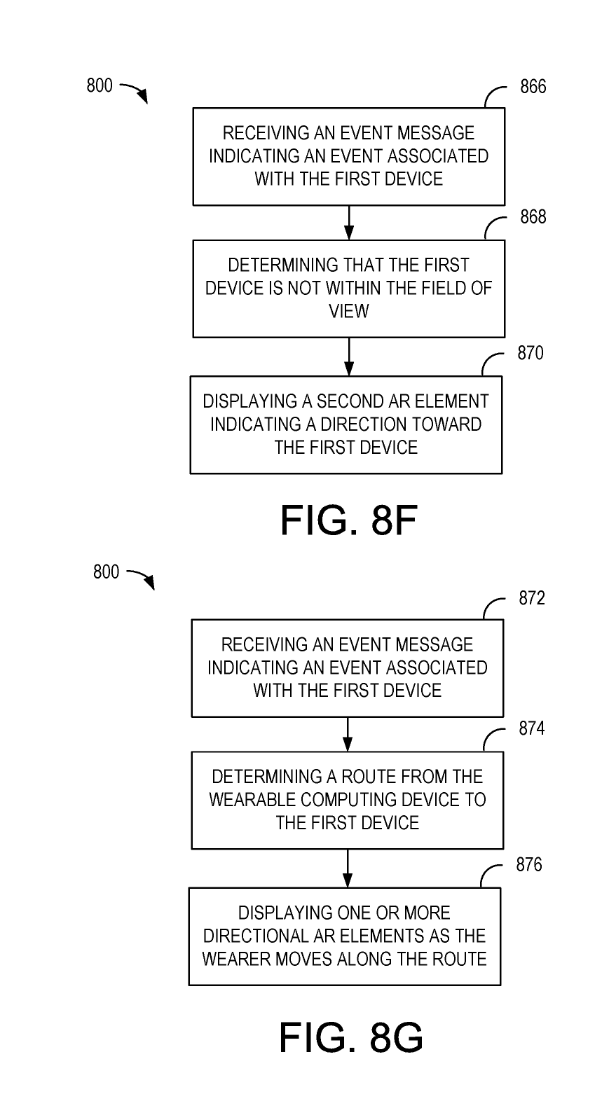

The site management system 100, in the example embodiment, also identifies one or more distance thresholds 612A, 612B (collectively, “thresholds 612”) (e.g., in units of distance) (not necessarily shown to scale in FIG. 6A). During operation, the thresholds 612 are used by the system 100 relative to the current location 606 of the HMD 601. For example, the threshold 612A may be 50 feet, and the threshold 612B may be 200 feet. As such, the two example thresholds 612 effectively define three “zones” 614A, 614B, and 614C (collectively, “zones 614”). More specifically, zone 614A represents the area circumscribed by the threshold 612A, zone 614B represents the area circumscribed by the threshold 612B but outside of the threshold 612A, and zone 614C represents the area outside of the threshold 612B. In other words, the thresholds 612 define the boundaries of the zones 614. As such, and as shown in FIG. 6A, devices 620A and 624 are in zone 614A, device 620B is in zone 614B, and device 620C is in zone 614C. It should be understood that, in the example embodiment, because these thresholds 612 are distances relative to the HMD 601, the zones 614 effectively move as the wearer 602 moves about the environment 600. This example embodiment is referred to herein as “user-relative determination,” as the thresholds 612 are implemented from the standpoint of distance from the HMD 601. Another embodiment, “device-relative determination,” is described below with respect to FIGS. 7A-7D.

During operation, the site management system 100 collects location information from the HMD 601 (e.g., determining the current location 606 on a regular basis, such as every 5 seconds, or every 15 seconds, via GPS on the HMD 601, or other location determination method). The system 100 also collects orientation data for the display device 101 (the direction the HMD 601 is facing, e.g., the field of view 608). Further, as described above, the system 100 also includes location information for each of the devices 620, 624 (e.g., locations 622, 626, respectively).

As the wearer 602 operates the HMD 601, the system 100 computes distances 628A, 628B, 628C (collectively, “distances 628”) from each of the devices 620 (and optionally 624) to the current location 606 of the HMD 601. In some embodiments, the site management server 630 receives the current location 606 data from the HMD 601 and computes the distances 628 using stored device locations 622, 626. In other embodiments, the site management server 630 transmits device locations 622, 626 to the HMD 601 and the HMD 601 computes the distances 628 (e.g., via comparison of GPS coordinates). For example, distance 628A may be 20 feet, distance 628B may be 100 feet, and distance 628C may be 500 feet.

Further, the system 100 uses the distances 628 and thresholds 612 to determine which zone 614 each device 620, 624 is presently in. In the example embodiment, the system 100 compares the distances 628 to the thresholds 612 to determine the associated zone 614 of the device 620. For example, the distance 628A to device 620A may be 20 feet, and the smallest threshold 612A may be 50 feet. As such, because the distance 628A to the device 620A is less than the smallest threshold 612A, the device 620A is determined to be in the nearest zone 614A. Similarly, the device 620B is at a determined distance 628B of 100 feet, which is between threshold 612A (e.g., 50 feet) and 612B (e.g., 200 feet), the device 620B is determined to be in middle zone 614B. And since the device 620C is at a determined distance 628C of 500 feet, which is greater than the largest threshold 612B (e.g., 200 feet), the device 620C is determined to be in the outer zone 614C.

In the example shown in FIG. 6A, two thresholds 612 and three zones 614 are depicted. It should be understood, however, that more or less thresholds 612 and zones 614 are possible, and are within the scope of this disclosure. Further, the thresholds 612 provided here are examples, and may be altered based on, for example, support considerations.

The display device 101 displays AR data associated with the devices 620 to the wearer 602 based on, for example, the distance 628 to the particular device 620, or based on the thresholds 612 or, in the example embodiment, based on the determined zone 614 of the particular device 620. More specifically, and in the example embodiment, devices in nearer zones 614 have more detailed AR data presented, and devices in further zones 614 have less-detailed AR data presented. Example AR data and illustrative views through the HMD 601 are shown and described below in respect to FIG. 6B.

FIG. 6B illustrates the field of view 608 of the wearer 602 as seen through the HMD 601 in the scenario shown in FIG. 6A. The illustrated elements shown in the field of view 608 are AR elements displayed to the wearer 602 via the HMD 601 in solid text or lines. Elements in broken lines are not displayed on the HMD 601 but, instead, may represent areas of interest to the present disclosure. Further, it should be understood that the real-world environment 600 within the field of view 608 is not depicted in FIG. 6B for purposes of highlighting the AR elements displayed by the HMD 601. In other words, during operation, the wearer 602 views the environment 600 through the HMD 601, and the HMD 601 would “overlay” the VR elements, shown and described herein, over the real world “backdrop.” Some of the VR elements may be particularly positioned in the field of view 608 relative to objects 116, 118 in the real-world environment 600, such as relative to the locations 622 of the devices 620 within the field of view 608.

FIG. 6B illustrates AR elements for each of the devices 620A, 620B, 620C shown in FIG. 6A and, more particularly, illustrates differing levels of AR data displayed by the HMD 601 based on the determined zone 614 of the device 620. As described above, the device 620C is in the outer zone 614C, and is depicted approximately centered and slightly above of a focus area 640 of the HMD 601. The focus area 640 is an area on the display 404 of the HMD 601 that is stationary with respect to the display 404, such that changes in the orientation of the HMD 601 alters what appears within the focus area 640. The device 620C is depicted higher than the other devices 620A, 620B in this example because the device 620C is farther away (e.g., 500 feet). The device 620B is depicted to the left of and slightly above (e.g., 100 feet away) the focus area 640, and the device 620A is depicted to the right of and slightly below (e.g., only 20 feet away) the focus area 640.

In the example embodiment, the HMD 601 displays one or more AR elements for each device in a device region 650A, 650B, 650C (collectively, “device regions 650”) of the field of view 608. The number and type of AR elements displayed in the device region 650 differs based on the zone 614 determined for the particular device 620. Each of the device regions 650 in this example includes a pair of brackets 642 bordering and approximately “framing” the location 622 of the device 620 (e.g., relative to the current location 606 and orientation of the HMD 601), serving to highlight the location 622 of the device 620 to the wearer 602. As such, each pair of brackets 642 may also be referred to herein as a frame 642.

At the approximate center of each frame 642 is a symbol area 644, represented in FIG. 6B by a broken “X”. The center of the symbol area 644 represents the area at which the device 620 would appear in the field of view 608 if the wearer 602 had a clear line of sight to the device 620. In the example embodiment, the HMD 601 displays a status symbol in the symbol area 644. Status data of each device 620 may be transmitted from the site management server 630 to the HMD 601 such as, for example, a power status (e.g., device is powered on or off), or a health status (e.g., normal, warning, alert, critical), or an operational value of significance to the status of the device (e.g., a current power output of a power generator, or a current operating temperature or pressure of a boiler). The HMD 601 receives the status data and displays a status symbol or a status value for each device 620 in the symbol area 644. For example, in embodiments providing power status, the HMD 601 may display a green circle element in the symbol area 644 if the associated device 620 is powered on, and a red “X” element if the device 620 is powered off, and a yellow “!” element if the status is unknown. As such, the wearer 602 is able to quickly determine the status of each device 620 via these AR status elements.

In some embodiments, the symbol area 644 may be shifted relative to the location 622 of the device 620 so as not to obscure real-world, line-of-sight visibility to the device 620 itself. Further, such off-center symbol shifting may be dependent upon the determined zone 614. For example, the wearer 602 is more likely to have line of sight to devices 620 that are closer to their current location 606. As such, the HMD 601 may shift the symbol area 644 off-center for devices 620 in the nearest zone 614A, and may leave the symbol area 644 centered for devices 620 in other zones 614B, 614C (e.g., because they are less likely to be in line of sight, and thus incur less risk of obscuring the wearer's view).

In some embodiments, the brackets 642 may be used similar to, or in lieu of, the symbol area 644. For example, the brackets 642 may be colored based on the status of the associated device 620 (e.g., green framing if status=“normal”, yellow framing if status=“warning”, orange framing if status=“alert”, and red framing if status=“critical”). As such, the framing serves both the function of identifying the location 622 of the device 620 and also the function of indicating status of that device 620.

In the example embodiment, the HMD 601 displays additional AR elements for devices 620 in zones 614 inside the outer-most zone 614C (e.g., for devices 620A and 620B, in zones 614A and 614B, respectively). Device regions 640A and 650B additionally include a detailed data area 652A and a summary data area 652B, respectively. More specifically, the HMD 601 displays the detailed data area 652A for devices 620 within the nearest zone 614A (e.g., device 620A), and the HMD 601 displays the summary data area 652B for devices 620 within the middle zone 614B (e.g., device 620B). The summary data area 652B may include summary data about the device 620B such as, for example, a device name or identifier, high-level progress data associated with an ongoing maintenance operation, distance to the device 620, or additional operational data. The detailed data area 652A may include detailed data about the device 620B such as, for example, device model, serial number, detailed progress data associated with the ongoing maintenance operation, and more detailed operational data.

During operation, as the wearer 602 moves about the environment 600, the determined zones 614 may change for each device 620. As mentioned above, the distances 628 from the HMD 601 to each device 620 are regularly or periodically recomputed and compared to the thresholds 612. In the example embodiment, as a particular device 620 crosses one of the thresholds 612 or changes zones 614, the AR elements displayed for the device 620 (e.g., in the associated device region 650) are changed based on the new zone 614. For example, presume the wearer 602 walks toward the farthest device, device 620C. The device 620C starts at 500 feet away from the wearer 602, and thus in the farthest zone 614C. As such, the HMD 601 displays only the framing 642 and status symbol area 644 AR elements for the device 620C. As the wearer 602 passes within 200 feet (the example threshold 612B), the system 100 determines that the device 620C is now in the middle zone 614B. As such, the HMD 601 displays the framing 642 and status symbol area 644 AR elements for the device 620C, and additionally the summary data area 652B. As the wearer 602 passes within 50 feet (the example threshold 612A), the system 100 determines that the device 620C is now in the nearest zone 614A. As such, the HMD 601 displays the framing 642 and status symbol area 644 AR elements for the device 620C, and additionally the detailed data area 652A. In some embodiments, the summary data area 652B may also be displayed in the nearest zone 614A. Further, in some embodiments, the status symbol area 644 may be removed or shifted from center as the device 620C enters the nearest zone 614A. Accordingly, the AR data displayed for each device 620 changes relative to the distance 628 between the wearer 602 or the HMD 601 and the device 620.

In some embodiments, the positioning of the data areas 652 (e.g., relative to their associated framing 642 or symbol area 644) may be shifted from the “above” position illustrated in FIG. 6B. For example, the data areas 652 may appear below, or to either side of the framing 642, adjacent to the framing 642, or centered in the symbol area 644. In some embodiments, the data area 652 may be shifted if the data area 652 would otherwise appear out of the field of view 608. For example, if the framing 642 was adjacent to the top of the field of view 608, then the HMD 601 may shift the data area 652 to appear below the framing 642.

In some embodiments, the positioning of the focus area 640 relative to the device regions 650 may cause alterations in the AR elements displayed by the HMD 601. FIG. 6C illustrates the field of view 608 if, for example, the wearer 602 were to look up slightly from the field of view 608 as shown in FIG. 6B such that the focus area 640 overlaps with the device region 650C of the device 620C. As mentioned above, the focus area 640, in the example embodiment, is fixed within the field of view 608 of the HMD 601 (e.g., at a stationary area of the display device within the HMD 601). In other embodiments, the focus area 640 may move within the field of view 608 such as, for example, based the focus of the eyes of the wearer 602. Because of the reorientation of the field of view 608, the real-world device 640A and associated AR elements are no longer visible in the field of view 608 (e.g., they have fallen below the lower edge of the field of view 608).

In this example, additional AR elements may be displayed by the HMD 601 if the focus area 640 is centered on a particular device 620 (e.g., if the focus area 640 overlaps the framing 642 or the symbol area 644 of the particular device 620). As the focus area 640 overlaps with the AR elements of the device 620C (e.g., symbol area 644), the HMD 601 additionally displays the summary data area 652B and populates that area with summary data associated with the device 620C. In other embodiments, the HMD 601 may additionally display the detailed data area 652A based on the positioning of the focus. As the user 102 moves the focus area 640 away from the device region 650C, the HMD 601 removes the additional AR elements (e.g., as shown in FIG. 6B). As such, the HMD 601 effectively changes the zone 614 in which the device 620 is considered to be, for purposes of displaying additional AR elements, based on the focus of the wearer 602.

In some embodiments, the wearer 602 may shift the focus area 640 to a device region 650, such as shown in FIG. 6C, but the HMD 601 may not automatically add or change AR elements for the associated device 620. Instead, the wearer 602 may input a toggle command (e.g., a voice command, or from a mechanical input device on the HMD 601), and the HMD 601 may alter the AR elements based on the toggle command. For example, the wearer 602 may shift the focus area 640 to the device region 650C (e.g., with no automatic alteration of AR elements), then enter the toggle command once. The HMD 601 may then add the summary data area 652B (e.g., changing “effective zone” of the device 620C from the outermost, determined zone 614C to the middle zone 614B). The wearer 602 may then enter another toggle command, and the HMD 601 may then add the detailed data area 652A, and optionally remove the summary data area 652B and/or the status symbol (e.g., changing the effective zone 614 of the device 620C from the middle zone 614B to the nearest zone 614A). This toggling may cycle through each of the available zones 614. As such, the wearer 602 may control or alter the level of AR detail being displayed for each device 620 manually, and in conjunction with the threshold mechanisms described herein.

FIG. 7A illustrates the site management system 100 providing AR assistance functionality to a wearer 602 of a HMD 601, which may be similar to the user 102 and the display device 101, respectively, shown in FIG. 1. In the example embodiment, the wearer 602 is a field service worker performing service operations in a work environment 700 (e.g., an oil refinery, a construction site, a power distribution grid). The site management system 100 includes a site management server 630 in communication with each of the wearer 602 through the HMD 601 (e.g., via wireless networking). The site management system 100 provides various event assist functionalities to the wearer 602 during an event such as, for example, an equipment failure, a malfunction, or a disaster. The wearer 602 may be involved with addressing the event (e.g., troubleshooting the failure, reacting to the malfunction, or fighting against the disaster).

In the example embodiment, the wearer 602 is working at a current location 706 (e.g., a work site such as an oil drilling site) while wearing the HMD 601. More specifically, the wearer 602 is performing a maintenance operation on an object 116 at the current location 706 and, as such, has the HMD 601 oriented, or posed, toward the object 116 (e.g., as illustrated by a field of view 708A).

The event occurs at an event site 720, and may involve or otherwise implicate one or more event objects 722 at the event site 720. The site management server 630 detects the event and assigns the wearer 602 to handling the event. The site management server 630 transmits an alert 704A to the wearer 602 and, more particularly, the HMD 601. This alert 704A is a notification message that causes the HMD 601 to present one or more AR display objects to the wearer 602.

FIG. 7B illustrates the field of view 708A of the wearer 602 as seen through the HMD 601 at the time the alert 704A is received by the HMD 601. At that time, as mentioned above, the wearer 602 is focused on a task involving the object 116. As such, the wearer 602 has the object 116 (not shown in FIG. 7B for purposes of clarity) oriented in a center region 740 of the field of view 708A (e.g., indicated by the broken line, which is included here for purposes of illustration, but is not an AR object visible to the user 102). In some embodiments, the center region 740 may be similar to the focus area 640. The HMD 601 presents AR display objects 744A, 744B (collectively, display objects 744) to the wearer 602 (e.g., to attract the attention of the wearer 602, or to alert the wearer 602 of the event, or to prompt the wearer 602 to reorient the HMD 601 to further investigate the event). The AR display objects 744 are illustrated in bold in FIGS. 7B-7D to signify that they are augmented reality content, as opposed to real-world objects 116, 118 viewed through the HMD 601.

In the example embodiment, the HMD 601 presents the AR objects 744 in one or more of a right-side periphery 742A and a left-side periphery 742B (collectively, periphery areas 742) of the field of view 708A. The AR objects 744 include a directional arrow indicator 744A (e.g., a right-pointing arrow) and a text element 744B (e.g., “Critical Event, Site X”). In the example embodiment, the task 704 includes location data of the event (e.g., the event site 720, the event object 722) and data for the text element 744B. The HMD 601 determines a shortest rotational direction from the current orientation of the HMD 601 (e.g., the direction of the field of view 708A) to an event field of view 708B (e.g., the direction at which the HMD 601 would have to be oriented in order to place the event site 720 or the event object 722 into the center region 740 of the HMD 601 display 404). The HMD 601 then provides the AR arrow indicator 744A, pointing in that shorted rotational direction, along with the text element 744B.

Referring again to FIG. 7A, this periphery alerting and notification shown in FIG. 7B causes the wearer 602 to read the text element 744B, determine that the associated event deserves his immediate attention, and reorient the HMD 601. More specifically, the wearer 602 rotates his head, and the HMD 601, in the direction of the arrow until the HMD 601 reaches the direction of the event site 720 (e.g., as illustrated by the event field of view 708B). At this stage, it should be noted that the wearer 602 has not necessarily moved from his current location 606, but has merely changed the orientation of the HMD 601 such as to point toward the event site 720.

FIG. 7C illustrates the event field of view 708B of the wearer 602 as seen through the HMD 601 after reorienting the HMD 601 to point toward the event site 720 (e.g., as prompted by the alert 704A and associated AR objects 744). As the wearer 602 rotates the HMD 601 around, the location 750 of the event site 720 or event object 722 comes into the field of view 708 of the HMD 601, as represented in FIG. 7C by the broken X. The location 750 is highlighted or otherwise identified to the wearer 602 by one or more AR objects 752A, 752B (collectively, AR objects 752).

The AR object 752A is an AR frame 642 surrounding or bordering an area around the location 750. The AR frame object 752A may be any open or closed shape sufficient to identify, frame 642, or halo the location 750 for the wearer 602, such as an ellipse, rectangle, or triangle. In the example embodiment, the directional arrow indicator 744A disappears or phases out as the location 750 enters or nears the field of view 708B and is replaced by the AR frame object 752A.

The AR object 752B is an AR arrow pointing at the location 750. In some embodiments, the directional arrow indicator 744A becomes or transforms into the AR arrow 752B (e.g., always pointing toward the location 750, whether in the field of view 708B or outside the field of view 708B). In other embodiments, the directional arrow indicator 744A disappears or phases out as the location 750 enters the field of view 708B and is replaced by a vertical AR arrow 752B. The vertical AR arrow 752B remains stationary relative to the location 750 and, as such, scrolls across the field of view 708B as the wearer 602 centers the location 750 within the field of view 708B.

The AR objects 752 serve to help the wearer 602 identify and center the location 750 in the field of view 708B. If the wearer 602 were near enough to the event site 720 and/or the event object 722 (and unobstructed by other real-world elements), the event site 720 or event object 722 would appear at location 750 on the field of view 708B (e.g., identified by one or more of the AR components 752). As the wearer 602 approximately centers the location 750 in the field of view 708B, the periphery areas 742 are changed or augmented with summary data 744C. The summary data 744C includes data that is most pertinent to the wearer 602 based on the timing of the event, or the wearer's 602 proximity to the event. The summary data 744C may include, for example, text data such as address or other site information for the location (e.g., so the wearer 602 might quickly determine which site 720 is impacted by the event), event summary information for the ongoing event (e.g., nature of the event, whether other services have been dispatched, level of criticality of the event), and equipment summary information (e.g., which event object(s) 722 are implicated by the event).

Referring again to FIG. 7A, the site management server 630 computes a path or route 710 from the current location 706 of the wearer 602 to the event site 720 and/or the event object 722. This route 710 may be, for example, driving directions (e.g., if the current location 706 and event site 720 are separate metro locations), or may be walking directions (e.g., if the current location 706 and event site 720 are on the same campus). Further, the HMD 601 provides AR navigational aids to the wearer 602, directing the wearer 602 through the route 710 as the wearer 602 moves toward the event site 720. As such, the HMD 601 enables the wearer 602 to navigate to the event site 720 hands-free, supported by the AR navigational aids.

The site management system 100 defines one or more thresholds 712A, 712B, 712C (collectively, thresholds 712) for the event and, in some embodiments, relative to the event site 720 (or event object 722). The thresholds 712, in the example embodiment, represent a distance 628 away from the event site 720. The thresholds 712 also define two or more zones 614 (not separately identified). For example, and as shown in FIG. 7A, the wearer 602 is farther away from the event site 720 than the first threshold 712A and, as such, is in the remotest zone 614 from the event site 720 (e.g., an “alerting zone”, outside of the first threshold 712A). While in this alerting zone, the HMD 601 provides AR objects 744, 752 such as those shown in FIGS. 7B and 7C.

As the wearer 602 moves closer to the event site 720, the wearer 602 transits zones 614, or crosses one or more thresholds 712, and the HMD 601 changes, augments, or otherwise alters the AR objects 744, 752 provided to the wearer 602 based on the thresholds 712 (e.g., based on which zone 614 the wearer 602 and HMD 601 is in). In the example embodiment, the wearer 602 crosses the first threshold 712A into a “planning zone” (e.g., between thresholds 712A and 712B), and the site management server 630 sends planning zone data 704B to the HMD 601 when the wearer 602 is determined to have crossed the threshold 712A (e.g., “threshold-instigated transfer”). In other embodiments, the site management server 630 may send data 704 prior to the wearer 602 crossing one of the thresholds 712, and the HMD 601 may store that data until detecting that the wearer 602 has crossed the associated threshold 712 (e.g., “preemptive transfer”).

FIG. 7D illustrates the event field of view 708B of the wearer 602 as seen through the HMD 601 after crossing the first threshold 712A (e.g., while in the planning zone). The HMD 601 may continue to provide other AR components while in the planning zone, such as one or more of the event location AR objects 752, AR text objects 744B, or AR summary data 744C. In the example embodiment, the HMD 601 also presents AR planning data 744D in the left-side periphery 742B. Planning zone data 744D represents data appropriate for the wearer 602 to know at or have while in the planning zone, such as, for example, what equipment or tools may be prescribed or helpful to have or acquire for addressing this event, or more detailed event data such as specific components that have failed, or sensor readings from site equipment (e.g., event object 722) that may be pertinent to the event.

Referring again to FIG. 7A, while in the planning zone, and/or while traveling the route 710, the site management system 100 may guide or route the wearer 602 to prescribed equipment. Further, the wearer 602 may alter their field of view 708 as they move along the route 710, and the HMD 601 may remove AR components to simplify the display 404 (e.g., when the current field of view 708 is away from the location 750). The wearer 602 may move through one or more other zones 614, such as defined by thresholds 712B and 712C, such as a site zone (e.g., when entering a campus of the event site 720), and the site management server 630 may send detailed event data 704C to the HMD 601. Once the wearer 602 crosses a nearest threshold 712C to the event site 720, such as when the wearer 602 is within feet or yards of the event object 722, the wearer 602 enters an execution zone (e.g., within threshold 712C), and the site management server 630 sends task data 704D to the HMD 601.

While in the execution zone, the HMD 601 provides AR components tailored toward execution of specific tasks 704 associated with addressing the event. The HMD 601 may remove navigational components and/or framing components, and may remove or alter periphery data such as objects 744B, 744C, 744D. The HMD 601 may present one or more AR task indicators associated with event tasks assigned to the wearer 602 to address the event, such as, for example, identifying or highlighting a nearby task component (e.g., the event object 722, or a particular dial or gauge on the event object 722, or a particular location at which to direct attention). The HMD 601 may also present task details such as, for example, instructions or steps to perform (e.g., as AR text objects in the periphery sections 742).

As such, the site management system 100 enables the wearer 602 to receive AR content through the HMD 601 responsive to the proximity of the wearer 602 to the event site 720, or to the timing relative to the event (e.g., greater detail as the event progresses). Further, this AR content is received hands-free via the HMD 601, enabling the wearer 602 to have his hands free for other tasks 704. The alert notification functionality enables the site management system 100 to reach and alert wearers 602 without having to resort to conventional means, such as cellphone contact to each individual. The planning and detail zoning functionality enables the site management system 100 to provide the information that the wearer 602 needs at a time when or as the wearer 602 most needs it, and allows the wearer 602 to receive this data hands-free (e.g., without having to manipulate a laptop computer or a smartphone). The tasking functionality enables the site management system 100 to provide task execution details directly to the wearer(s) 602 addressing the event, contemporaneously with their need (e.g., as they arrive, or as they execute the event tasks), and while keeping their hands free to execute the tasks 704.

While the processing steps may be described above in as being performed by the site management server 630, the HMD 601, or the site management system 100 overall, it should be understood that those steps may be performed by other components of the site management system 100 that enable the systems and methods described herein.

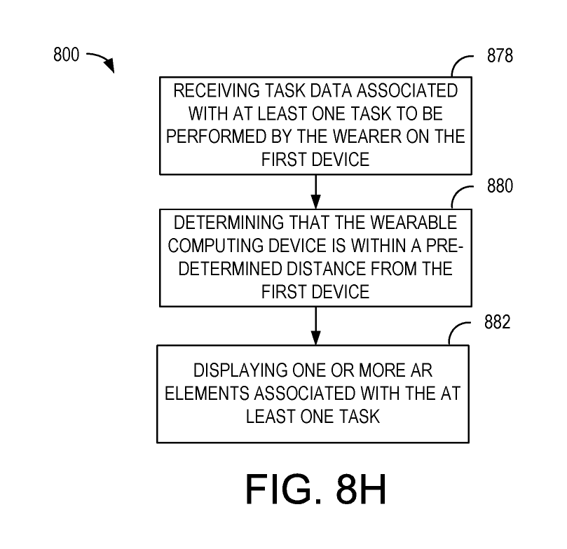

FIGS. 8A-8H illustrate a computerized method 800, in accordance with an example embodiment, for providing AR assist functionality to a wearer 102, 602 of an display device 101, 601. The computerized method 800 is performed by a computing device comprising at least one processor 502 and a memory. In the example embodiment, the computerized method 800 includes identifying a location of a wearable computing device within an environment (see operation 810). The wearable computing device includes a display element configured to display augmented reality (AR) content to a wearer 602. The display element presents a field of view 708 to the wearer 602 based on an orientation of the wearable computing device. The method 800 also includes identifying a location of a first device within the environment (see operation 820).

At operation 830, the method 800 includes receiving an operating status of the first device. At operation 840, the method 800 includes determining a first AR element associated with the first device based on the operating status of the first device and the location of the first device relative to the location of the wearable computing device. At operation 850, the method 800 includes displaying the first AR element using the display element. The first AR element is displayed at a display location approximately aligned with or proximate to the location of the first device within the field of view 708.

In some embodiments, the method 800 also includes identifying a first threshold value 712A (see operation 832), computing a first distance between the location of the wearable computing device and the location of the first device (see operation 834), and determining that the first distance is less than the threshold 712 (see operation 836), and determining the first AR element associated with the first device based on the location of the first device relative to the location of the wearable computing device (see operation 840) is based on the determining that the first distance is less than the threshold 712.

In some embodiments, the method 800 includes identifying a second AR element associated with the first device (see operation 842) and, prior to displaying the first AR element (see operation 850), displaying the second AR element to the wearer 602 using the display element, the second AR element is displayed at a display location approximately aligned with or proximate to the location of the first device in the field of view 708 (see operation 844). In some embodiments, the method 800 includes determining a status of the first device, and determining a status symbol associated with the status, wherein one of the first AR element and the second AR element includes the status symbol. In some embodiments, the first AR element is one of (1) a status symbol associated with a status of the first device and (2) operational data associated with the first device.

In some embodiments, the method 800 further includes determining that the display location is at least partially outside of the field of view 708 (see operation 846), and altering the display location such that the first AR element is entirely within the field of view 708 (see operation 848). In some embodiments, the method 800 includes identifying a focus area 640 within the field of view 708 (see operation 860), determining that the focus area 640 is within a pre-determined distance of, or at least partially overlaps, at least one of the location of the first device in the field of view 708 and the first AR element (see operation 862), and displaying a second AR element associated with the first device to the wearer 602 using the display element (see operation 864).

In some embodiments, the method 600 also includes receiving an event message indicating an event associated with the first device (see operation 866), determining that the first device is not within the field of view (see operation 868), and displaying a second AR element using the display element, the second AR element indicating a direction toward the first device (see operation 870), wherein displaying the first AR element occurs when the first device is brought within the field of view. In some embodiments, the method 600 includes receiving an event message indicating an event associated with the first device (see operation 872) and, based on receiving the event message, determining a route from the location of the wearable computing device to the location of the first device (see operation 874), and displaying one or more directional AR elements on the display device as the wearer moves along the route (see operation 876). In some embodiments, the method 600 includes receiving task data associated with at least one task to be performed by the wearer on the first device (see operation 878), determining that the wearable computing device is within a pre-determined distance from the first device (see operation 880) and, based on the determining that the wearable computing device is within a pre-determined distance from the first device, displaying one or more AR elements associated with the at least one task using the display element (see operation 882).

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 9 is a block diagram of a machine in the example form of a computer system 900 within which instructions 924 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation (or cursor control) device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media 922. The instructions 924 may also reside, completely or at least partially, within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions 924 for execution by the machine and that cause the machine to perform any one or more of the methodologies of the present embodiments, or that is capable of storing, encoding or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 924 may further be transmitted or received over a communications network 926 using a transmission medium. The instructions 924 may be transmitted using the network interface device 920 and any one of a number of well-known transfer protocols (e.g., Hypertext Transfer Protocol (HTTP)). Examples of communication networks include a local area network (LAN), a wide area network (WAN), the Internet, mobile telephone networks, plain old telephone service (POTS) networks, and wireless data networks (e.g., Wi-Fi and WiMax networks). The term “transmission medium” shall be taken to include any intangible medium capable of storing, encoding, or carrying instructions 924 for execution by the machine, and includes digital or analog communications signals or other intangible media to facilitate communication of such software.

### Example Mobile Device

FIG. 10 is a block diagram illustrating a mobile device 1000, according to an example embodiment. The mobile device 1000 may include a processor 1002. The processor 1002 may be any of a variety of different types of commercially available processors 1002 suitable for mobile devices 1000 (for example, an XScale architecture microprocessor, a microprocessor without interlocked pipeline stages (MIPS) architecture processor, or another type of processor 1002). A memory 1014, such as a random access memory (RAM), a flash memory, or other type of memory, is typically accessible to the processor 1002. The memory 1014 may be adapted to store an operating system (OS) 1006, as well as application programs 1008, such as a mobile location enabled application that may provide LBSs to a user. The processor 1002 may be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 may be coupled to a transceiver 1014 that interfaces with an antenna 1016. The transceiver 1014 may be configured to both transmit and receive cellular network signals, wireless data signals, or other types of signals via the antenna 1016, depending on the nature of the mobile device 1000. Further, in some configurations, a GPS receiver 1018 may also make use of the antenna 1016 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A wearable computing device comprising:
at least one processor;
a display element configured to display augmented reality (AR) content to a wearer of the wearable computing device, the display element presenting a field of view to the wearer based on an orientation of the wearable computing device;
a location sensor providing location information associated with the wearable computing device; and
an augmented reality (AR) engine, executed by the at least one processor, configured to perform operations comprising:
identifying a location of the wearable computing device within an environment;
identifying a location of a first device within the environment;
receiving an operating status of the first device;
determining a first AR element associated with the first device based on the operating status of the first device and the location of the first device relative to the location of the wearable computing device; and
displaying the first AR element using the display element, the first AR element is displayed at a display location approximately aligned with or proximate to the location of the first device within the field of view.

2. The wearable computing device of claim 1, wherein the AR engine is further configured to perform operations comprising:
identifying a first threshold value;
computing a first distance between the location of the wearable computing device and the location of the first device; and
determining that the first distance is less than the first threshold value,
wherein determining the first AR element associated with the first device based on the location of the first device relative to the location of the wearable computing device is based on the determining that the first distance is less than the first threshold value.

3. The wearable computing device of claim 1, wherein the AR engine is further configured to perform operations comprising:
identifying a second AR element associated with the first device; and
prior to displaying the first AR element, displaying the second AR element using the display element, the second AR element is displayed at a display location approximately aligned with, or proximate to, the location of the first device in the field of view.

4. The wearable computing device of claim 3, wherein the AR engine is further configured to perform operations comprising:
determining a status of the first device; and
determining a status symbol associated with the status,
wherein one of the first AR element and the second AR element includes the status symbol.

5. The wearable computing device of claim 1, wherein the first AR element is one of (1) a status symbol associated with a status of the first device and (2) operational data associated with the first device.

6. The wearable computing device of claim 1, wherein the AR engine is further configured to perform operations comprising:
determining that the display location is at least partially outside of the field of view; and
altering the display location such that the first AR element is entirely within the field of view.

7. The wearable computing device of claim 1, wherein the AR engine is further configured to perform operations comprising:
identifying a focus area within the field of view;
determining that the focus area is within a pre-determined distance of, or at least partially overlaps, at least one of the location of the first device in the field of view and the first AR element; and
displaying a second AR element associated with the first device using the display element.

8. The wearable computing device of claim 1, wherein the AR engine is further configured to perform operations comprising:
receiving an event message indicating an event associated with the first device;
determining that the first device is not within the field of view; and
displaying a second AR element using the display element, the second AR element indicating a direction toward the first device,
wherein displaying the first AR element occurs when the first device is brought within the field of view.

9. The wearable computing device of claim 1, wherein the AR engine is further configured to perform operations comprising:
receiving an event message indicating an event associated with the first device;
based on receiving the event message, determining a route from the location of the wearable computing device to the location of the first device; and
displaying one or more directional AR elements on the display device as the wearer moves along the route.

10. The wearable computing device of claim 1, wherein the AR engine is further configured to perform operations comprising:
receiving task data associated with at least one task to be performed by the wearer on the first device;
determining that the wearable computing device is within a pre-determined distance from the first device; and
based on the determining that the wearable computing device is within a pre-determined distance from the first device, displaying one or more AR elements associated with the at least one task using the display element.

11. A computer-implemented method comprising:
identifying a location of a wearable computing device within an environment, the wearable computing device including a display element configured to display augmented reality (AR) content to a wearer, the display element presenting a field of view to the wearer based on an orientation of the wearable computing device;
identifying a location of a first device within the environment;
receiving an operating status of the first device;
determining a first AR element associated with the first device based on the operating status of the first device and the location of the first device relative to the location of the wearable computing device; and
displaying the first AR element using the display element, the first AR element is displayed at a display location approximately aligned with or proximate to the location of the first device within the field of view.

12. The method of claim 11, further comprising:
identifying a first threshold value;
computing a first distance between the location of the wearable computing device and the location of the first device; and
determining that the first distance is less than the first threshold value,
wherein determining the first AR element associated with the first device based on the location of the first device relative to the location of the wearable computing device is based on the determining that the first distance is less than the first threshold value.

13. The method of claim 11, further comprising:
identifying a second AR element associated with the first device; and
prior to displaying the first AR element, displaying the second AR element using the display element, the second AR element is displayed at a display location approximately aligned with or proximate to the location of the first device in the field of view.

14. The method of claim 13, further comprising:
determining a status of the first device; and
determining a status symbol associated with the status,
wherein one of the first AR element and the second AR element includes the status symbol.

15. The method of claim 11, wherein the first AR element is one of (1) a status symbol associated with a status of the first device and (2) operational data associated with the first device.

16. The method of claim 11, further comprising:
determining that the display location is at least partially outside of the field of view; and
altering the display location such that the first AR element is entirely within the field of view.

17. The method of claim 11, further comprising:
identifying a focus area within the field of view;
determining that the focus area is within a pre-determined distance of, or at least partially overlaps, at least one of the location of the first device in the field of view and the first AR element; and
displaying a second AR element associated with the first device using the display element.

18. The method of claim 11, further comprising:
receiving an event message indicating an event associated with the first device;
determining that the first device is not within the field of view; and
displaying a second AR element using the display element, the second AR element indicating a direction toward the first device,
wherein displaying the first AR element occurs when the first device is brought within the field of view.

19. The method of claim 11, further comprising:
receiving an event message indicating an event associated with the first device;
based on receiving the event message, determining a route from the location of the wearable computing device to the location of the first device; and
displaying one or more directional AR elements on the display device as the wearer moves along the route.

20. A non-transitory machine-readable medium storing processor-executable instructions which, when executed by a processor, cause the processor to perform operations comprising:
identifying a location of a wearable computing device within an environment, the wearable computing device including a display element configured to display augmented reality (AR) content to a wearer, the display element presenting a field of view to the wearer based on an orientation of the wearable computing device;
identifying a location of a first device within the environment;
receiving an operating status of the first device;
determining a first AR element associated with the first device based on the operating status of the first device and the location of the first device relative to the location of the wearable computing device; and
displaying the first AR element using the display element, the first AR element is displayed at a display location approximately aligned with or proximate to the location of the first device within the field of view.
